(19) United States
(12) Patent Application Publication
(10) Pub. No.: US 2021/0344836 A1
(43) Pub. Date: Nov. 4, 2021

(54) INFORMATION PROCESSING DEVICE, SETTING METHOD THEREFOR, AND PROGRAM

(71) Applicant: Nippon Telegraph and Telephone Corporation, Tokyo (JP)

(72) Inventors: Kotaro Ono, Tokyo (JP); Ryota Ishibashi, Tokyo (JP); Takeshi Kuwahara, Tokyo (JP)

(21) Appl. No.: 17/261,815

(22) PCT Filed: Jul. 25, 2019
(86) PCT No.: PCT/JP2019/029284

§ 371 Date: Jan. 20, 2021

(30) Foreign Application Priority Data
Jul. 27, 2018 (JP) 2018-141103

(51) Int. Cl. H04N 5/232

(52) U.S. Cl. CPC H04N 5/23229

(57) ABSTRACT

An information processing device is provided that is capable of automatically setting an appropriate information processing rule in accordance with the environment of terminals and a computing device. An information processing device 100 includes: an information receiving unit 110 for receiving information from a first terminal 10-1 and a second terminal 10-2; an information processing unit 120 for processing the information received from the first terminal 10-1, conforming to an information processing rule, based on the information received from the second terminal 10-2; an information transmission unit 130 for transmitting, to a computing device 20-1, the information from the first terminal 10-1 that has been processed by the information processing unit 120; and an information processing method determination unit 211 for determining a processing method for processing the information received from the second terminal 10-2 in the information processing unit 120, based on at least one of an information processing status in the computing device 20-1 and a device status of the computing device 20-1, creating the information processing rule, and setting the created information processing rule to the information processing unit 120.

### TECHNICAL FIELD

The present invention relates to a system and a method for setting a rule for performing information processing in a system in which a computing device is connected to a plurality of terminals via a network and performs processing, when processing information transmitted by a terminal between the computing device and the terminal, based on another information transmitted by a terminal.

### BACKGROUND ART

With the development of IoT (Internet of Things), technologies and services that utilize various types of terminals connected to a network (NW) and a large amount of information acquire by those terminals are being studied. In the IoT, effective use of a large number of sensors connected to a NW (e.g. microphones for acquiring audio information, cameras for acquiring image information, measurement devices for acquiring environmental information such as temperature, humidity, and luminance, measurement devices for acquiring operational information such as the velocity, orientation, and position of a machine) is picked up as an issue, and usage methods have been studied in which not only information that can be acquired by individual terminals connected to the NW, i.e. sensor information in the above example is solely used, but also information from a plurality of terminals is used in combination, or statistical processing is performed to analyze the information.

In addition, if each terminal can transmit and receive information via the NW to and from the outside thereof, conventionally, decentralization of terminal functions using external resources can also be achieved; for example, the terminal itself, or a control function of the terminal disposed in the NW that is closed at the site where the terminal is installed can be disposed on the cloud or at an edge of the NW near the terminal. Disposing some terminal functions together on the cloud or at an edge of a NW close to the terminal will eliminate the need to implement advanced functions for providing intelligent terminal control and high value-added services on individual terminals, thereby enabling expansion of services using the advanced functions while reducing the cost of the terminals themselves and the cost of maintenance and operation.

When it is considered to use a combination of multiple separate pieces of information acquired by terminals on the cloud or at an edge of a NW, it is necessary to determine a rule on how multiple pieces of information are to be combined and used or processed. For example, if information that is transmitted in real time by one terminal (terminal 1) is to be processed based on information that is transmitted in real time by another terminal (terminal 2), it is necessary to determine, in advance, a rule for processing the information from the terminal 1 that is based on information from the terminal 2, and a method for setting this rule.

A firewall is an example of existing mechanisms for processing information, such as packets, based on a predetermined rule, but in the firewall, a rule for packet processing is set based on a method for operating the network and an application that is predetermined by a user, and packets are monitored and processed by the firewall. To simply configure settings of a firewall without errors, there is a widespread method of automatically setting a dynamic firewall and a packet processing rule using predefined profiles, such as “a port A is released when an operation of an application A is sensed” or “ corresponding control traffic is allowed when a service B is used” when a widely-used application or a general-purpose service is used. Further, a method of automatically reflecting a manually-created profile and packet processing rule in a plurality of firewalls also exists as an existing technology (see NPL 1).

### CITATION LIST

### Non Patent Literature

[NPL 1] Toshio Shimojo and 2 others, “Design and Implementation of Policy-Driven Firewall Configuration”, Journal of the Institute of Electronics, Information and Communication Engineers B, Vol. J87-B, No. 10, pp. 1616-1625, Oct. 1, 2004

### SUMMARY OF THE INVENTION

### Technical Problem

When information that is transmitted in real time by one terminal (terminal 1) is to be processed based on information that is transmitted in real time by another terminal (terminal 2), a rule for processing the information from the terminal 1 that is based on the information from the terminal 2 needs to be determined in advance. If the rule for processing information from the terminal 1 is manually created through preliminary experiments or the like conducted in advance, based on the characteristics of the terminal 1 and the terminal 2 and the method for using the information from the terminal 1, it is necessary to go through a trial-and-error process to set appropriate information processing rule for each of the terminals to be used and each of the methods for using information, and it is significantly time-consuming to create the rules. In addition, if the methods for using the terminals and information transmitted by the terminals are updated and modified, an information processing rule needs to be created again as necessary. Further, preliminary experiments or the like need be conducted in advance to create the information processing rule while assuming many cases such as the environments in which terminals are installed and a use status thereof, in order to achieve a state where both a recipient of information processed and a user of the information from the terminal based on the information processing rule always satisfy required conditions.

The present invention has been made in view of the foregoing circumstances, and an object of the invention is to provide an information processing device capable of automatically setting an appropriate information processing rule in accordance with the environments of terminals and a computing device.

### Means for Solving the Problem

As a means to solve the above-described problem, according to the present invention, the actual processing status of terminal information that is processed based on an information processing rule, and the actual processing status of a device that uses and processes information from a terminal that has been processed based on the information processing rule are collected, and the information processing rule that satisfies the processing state required by the device that uses and processes the information from the terminal is automatically create, set, and updated based on the relationship between the collected status and an information processing rule that is currently set.

That is to say, the present invention is an information processing device disposed on a communication path between a first terminal and a second terminal that transmit different kinds of information in real time and a computing device that processes the information transmitted from the first terminal, the information processing device including: an information receiving unit for receiving the information from the first terminal and the second terminal; an information processing unit for processing the information received from the first terminal, conforming to an information processing rule, based on the information received from the second terminal; an information transmission unit for transmitting, to the computing device, the information from the first terminal that has been processed by the information processing unit; and an information processing method determination unit for determining a processing method for processing the information received from the second terminal in the information processing method determination unit, based on at least one of an information processing status in the computing device and a device status of the computing device, creating the information processing rule, and setting the created information processing rule to the information processing unit.

### EFFECTS OF THE INVENTION

When information that is transmitted in real time by one terminal (terminal 1) is to be processed based on information that is transmitted in real time by another terminal (terminal 2), according to the present invention, a rule for processing the information from the terminal 1 that is based on the information from the terminal 2 is to be determined in advance, and this information processing rule need not be created while manually adjusting it. By allowing this solving means to constantly function even in a situation where terminal information is being processed, even if a change occurs that has not been initially unexpected since processing of the terminal information started, such as the terminal being placed in an unexpected environment or a drastic change in the environment around the terminal, the rule for processing the terminal information can be modified in real time in accordance with the actual processing status of the terminal information to be processed based on the information processing rule and the actual processing status of the device that uses or processes the information from the terminal. That is to say, the rule for processing the information from the terminals can be modified as necessary so as to satisfy the processing status required by the device that uses or processes the information from the terminals. In addition, an increase, a modification, and a change in the required condition in the method for using or processing the information from the terminals can be dynamically responded.

### BRIEF DESCRIPTION OF DRAWINGS

FIG. 1 is a schematic configuration diagram of a system that is a premise of the present invention.

FIG. 2 is a schematic configuration diagram of an information processing rule setting system according to the present invention.

FIG. 3 is a functional block diagram of the information processing rule setting system.

FIG. 4 is a sequence chart of the information processing rule setting system.

FIG. 5 is a flowchart of an information processing method determination unit.

FIG. 6 is a functional block diagram of the information processing rule setting system according to Example 1.

FIG. 7 is a flowchart of a sensor information processing unit according to Example 1.

FIG. 8 is a flowchart of the sensor information processing method determination unit according to Example 1 (1/2).

FIG. 9 is a flowchart of the sensor information processing method determination unit according to Example 1 (2/2).

FIG. 10 is a flowchart of the sensor information processing method determination unit according to Example 2 (1/2).

FIG. 11 is a flowchart of the sensor information processing method determination unit according to Example 2 (2/2).

FIG. 12 is a flowchart of the sensor information processing method determination unit according to Example 3 (1/2).

FIG. 13 is a flowchart of the sensor information processing method determination unit according to Example 3 (2/2).

FIG. 14 is a flowchart of the sensor information processing method determination unit according to Example 4 (1/2).

FIG. 15 is a flowchart of the sensor information processing method determination unit according to Example 4 (2/2).

FIG. 16 is a functional block diagram of the information processing rule setting system according to Example 5.

FIG. 17 is a flowchart of a velocity/luminance information processing unit according to Example 5.

FIG. 18 is a flowchart of a velocity/luminance information processing method determination unit according to Example 5 (1/2).

FIG. 19 is a flowchart of the velocity/luminance information processing method determination unit according to Example 5 (2/2).

FIG. 20 is a flowchart of the velocity/luminance information processing method determination unit according to Example 6 (1/2).

FIG. 21 is a flowchart of the velocity/luminance information processing method determination unit according to Example 6 (2/2).

FIG. 22 is a flowchart of the velocity/luminance information processing method determination unit according to Example 7 (1/2).

FIG. 23 is a flowchart of the velocity/luminance information processing method determination unit according to Example 7 (2/2).

FIG. 24 is a flowchart of the velocity/luminance information processing method determination unit according to Example 8 (1/2).

FIG. 25 is a flowchart of the velocity/luminance information processing method determination unit according to Example 8 (2/2).

### DESCRIPTION OF EMBODIMENTS

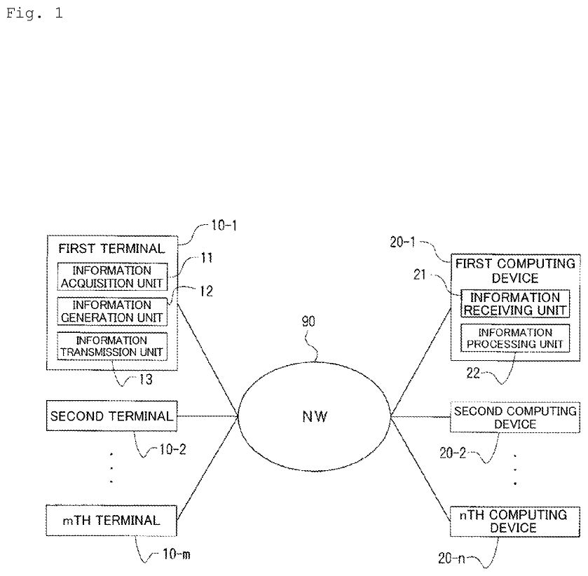

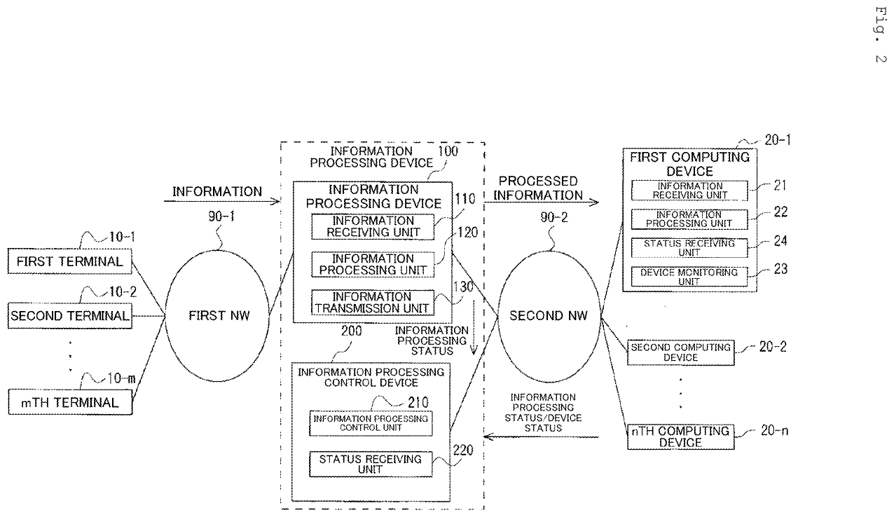

An embodiment of an information processing rule setting system and a setting method according to the present application will be described in detail with reference to the drawings. FIG. 1 is a schematic configuration diagram of a system that is a premise of the present invention, and FIG. 2 is a schematic configuration diagram of an information processing rule setting system according to the present invention. Note that, in the present application, multiple like devices and constituents are assigned common primary reference numerals, and branch numbers follow the primary reference numerals in order to individually reference the devices and constituents. When multiple like devices and constituents are generically named, only the primary reference numerals are used.

As shown in FIG. 1, each terminal 10 includes an information acquisition unit 11 that acquires information, an information generation unit 12 that generates information, and an information transmission unit 13 that transmits, in real time, the information acquired by the information acquisition unit 11 and the information generated by the information generation unit 12 to an external device connected to a NW 90. The terminals 10 transmit different kinds of information in real time. Each of the terminals 10 may alternatively be configured to include either one of the information acquisition unit 11 and the information generation unit 12.

Each computing device 20 includes an information receiving unit 21 that receives information transmitted from the terminals 10 connected to the NW 90, and an information processing unit 22 that performs information processing, including retransmission of the information.

As shown in FIG. 2, in the information processing rule setting system according to the present invention, an information processing device 100 is disposed on an information communication path from the terminals 10 to the computing devices 20. In an example in FIG. 2, the terminals 10 are connected to a NW 90-1, the computing devices 20 are connected to a NW 90-2, and the information processing device 100 is connected to the NWs 90-1 and 90-2.

The information processing device 100 has an information receiving unit 110 that receives information that is transmitted in real time by each of the terminals 10, an information processing unit 120 that uses the received information solely or a combination of a plurality of pieces of information, and processes information that is transmitted in real time from another terminal 10 based on a set information processing rule, and an information transmission unit 130 that transmits the processed information to an external device connected to the NW 90-2 that is any of the computing devices 20 in this case.

An information processing control device 200 includes an information processing control unit 210 that is a functional unit for setting the information processing rule used in the information processing unit 120 of the information processing device 100, and a status receiving unit 220 that receives an information processing status/device status in the computing devices 20 that is transmitted therefrom. The information processing control unit 210 sets the information processing rule based on (a) a set information processing rule, (b) the processing status of information acquired from the information processing unit 120, (c) the information processing status/device status in the computing devices 20 received from the status receiving unit 220, and (d) the information processing status/device status required by the computing devices 20.

Although, in FIG. 2, the information processing control unit 210 and the status receiving unit 220 are present as the information processing control device 200 independently from the information processing device 100, the information processing control unit 210 and the status receiving unit 220 may alternatively be included in the information processing device 100.

The information processing device 100 and the information processing control device 200 are mainly constituted by semiconductor devices, and can be configured as so-called information processors that have a CPU (Central Processing Unit), a volatile storage device such as a RAM (Random Access Memory), a nonvolatile storage device such as a hard disk or a flash memory, and a communication interface for connection for communication with external devices. Also, the information processing device 100 and the information processing control device 200 are not limited to physical network devices such as a switch and a router, and may include a physical computer and a virtualized computer on which the program of the present invention operates.

Each of the computing devices 20 includes, in addition to the information receiving unit 21 that receives information transmitted by the information processing device 100 shown in FIG. 1 and the information processing unit 22 that processes information transmitted by the terminals 10, a device monitoring unit 23 that monitors the device status of the computing device 20, and a status transmission unit 24 that transmits the information processing status/device status in the computing device 20 that is acquired from the information processing unit 22 and the device monitoring unit 23, to an external device that is the status receiving unit 220 in this case.

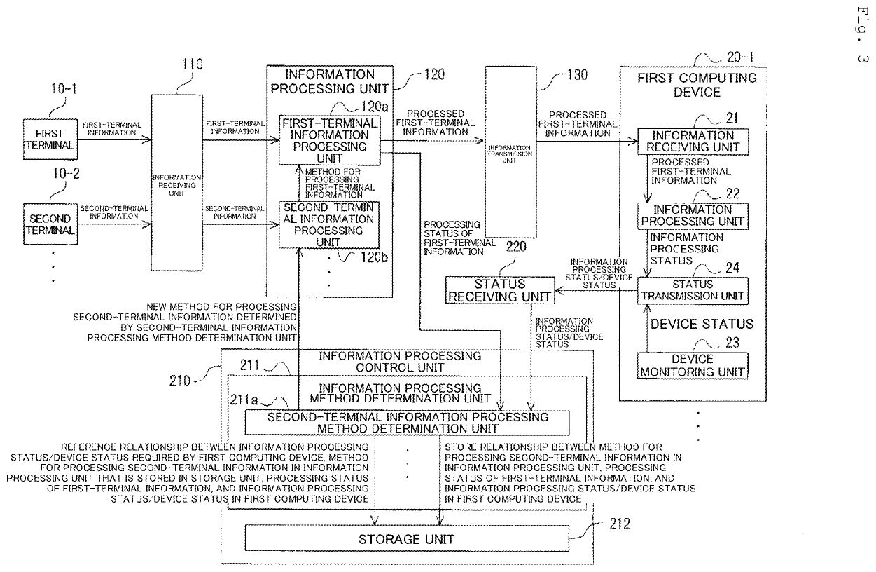

Next, the details of the information processing rule setting system will be described with reference to FIG. 3. FIG. 3 is a functional block diagram of the information processing rule setting system. In the information processing unit 120 of the information processing device 100 in FIG. 2, information that is transmitted in real time from a terminal 10 (here, a first terminal 10-1) is processed in accordance with an information processing rule that is based on information that is transmitted in real time from another terminal 10 (here, a second terminal 10-2), and then the processed information is transmitted to any of the computing devices 20 via the information transmission unit 130. Thus, the flow of information transmitted to a second NW 90-2 in FIG. 2 is “changed”. The first terminal 10-1 and the second terminal 10-2 transmit different kinds of information in real time.

Here, the aforementioned “change” means a change that is advantageous for users of the terminals 10, the computing devices 20, and the NWs 90 to which the terminals 10 and the computing devices 20 are connected, such as reducing unnecessary usage of an NW band and the processing load of the computing devices 20, or increasing the information processing accuracy of the computing devices 20, by the information processing device 100 discarding information that need not be transmitted to the computing devices 20 due to a problem of quality or the like of information, for example. An information processing rule for generating this “change” is created by an information processing method determination unit 211 in the information processing control unit 210, and this rule is set to the information processing unit 120 of the information processing device 100.

FIG. 3 shows functional blocks necessary for creating, setting, and updating the information processing rule of the first terminal 10-1 that is based on information transmitted in real time from the second terminal 10-2, in order to process, in the information processing device 100, information transmitted in real time from the first terminal 10-1 to the first computing device 20-1.

The information processing method determination unit 211 (here, a second-terminal information processing method determination unit 211a) in the information processing control unit 210 collects the actual processing status of information from the first terminal 10-1 that is to be processed based on a rule for processing the information from the first terminal 10-1, the rule being set to the information processing unit 120 of the information processing device 100, and the actual information processing status/device status in the first computing device 20-1 that uses or processes the information from the first terminal 10-1 that has been processed based on the information processing rule. Furthermore, the information processing method determination unit 211 creates an information processing rule that satisfies the information processing status/device status required by the first computing device 20-1 that is stored in advance in the storage unit 212, based on the relationship between the above-collected status and an information processing rule that is currently set. Here, a method for processing information from the second terminal 10-2 is determined, and is set to the information processing unit 120 (here, a second-terminal information processing unit 120b). The created and set information processing rule, the processing status of the information from the first terminal 10-1, and the information processing status/device status in the first computing device 20-1 are stored in the storage unit 212 as needed.

The information processing method determination unit 211 acquires the actual processing status of information from a terminal 10 that is processed based on the information processing rule, via the information processing unit 120 of the information processing device 100. The information processing method determination unit 211 also acquires, via the status receiving unit 220, the actual processing status of a device that uses or processes information from the terminal 10 that has been processed based on the information processing rule. The above information may be acquired either by notifying the information processing method determination unit 211 of the information, or by the information processing method determination unit 211 using a request-response method. In addition, as for the method for acquiring the information, the information may be acquired from the inside of the device or from the outside via a network.

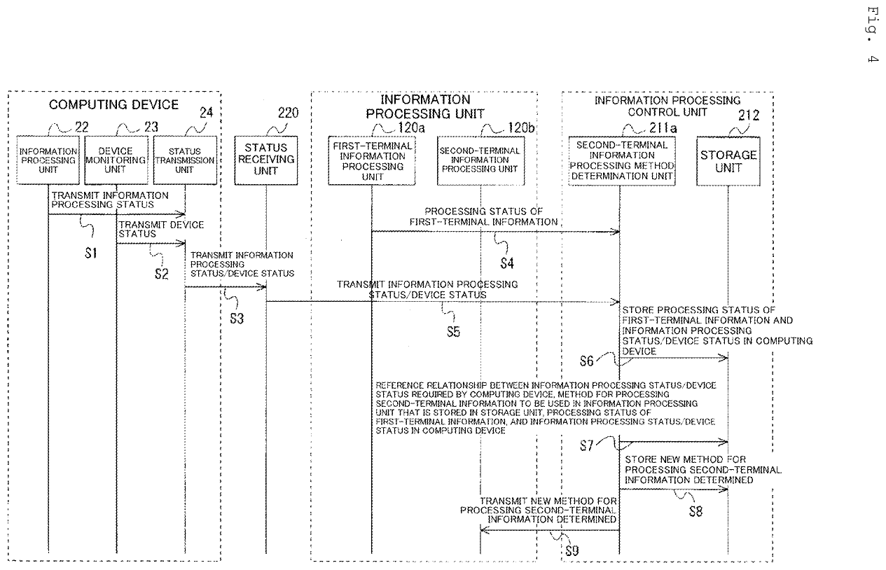

Next, a description will be given, with reference to a sequence chart in FIG. 4, of a flow of setting the information processing rule used in the information processing unit 120 of the information processing device 100.

The information processing unit 22 and the device monitoring unit 23 of the computing device 20 transmits the information processing status and the device status, respectively, to the status transmission unit 24 (steps S1 and S2). The status transmission unit 24 transmits the information processing status/device status in the computing device 20 to the status receiving unit 220 (step S3). The status receiving unit 220 and the information processing unit 120 (here, a first-terminal information processing unit 120a) of the information processing device 100 transmit the information processing status/device status in the computing device 20 and the processing status of first-terminal information in the information processing device 100, to the information processing method determination unit 211 (here, the second-terminal processing method determination unit 211a) in the information processing control unit 210 (steps S4 and S5).

The second-terminal information processing method determination unit 211a stores the received information in the storage unit 212. Further, the second-terminal information processing method determination unit 211a determines a method for processing second-terminal information, based on the information (relationship between the information processing status/device status required by the computing device 20, the method for processing the second-terminal information in the information processing device 100, the processing status of the first-terminal information, and the information processing status/device status in the computing device 20) that is stored in the storage unit 212. Further, the second-terminal information processing method determination unit 211a stores the determination result in the storage unit 212, and transmits the determination result to the second-terminal information processing unit 120b (steps S6 to S9). Thus, the method for processing the information from the first terminal 10-1, i.e. the information processing rule is created and set, and information processing is performed based on the set rule.

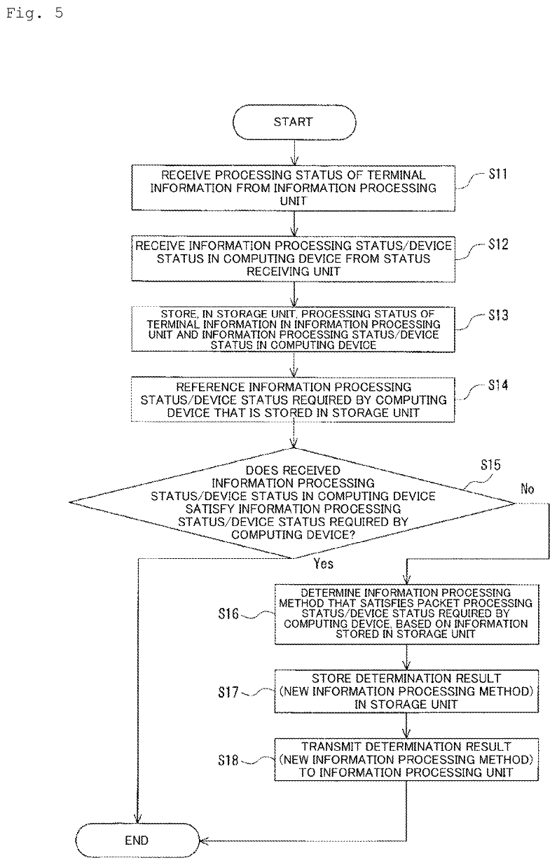

A flow in the information processing method determination unit 211 will be described with reference to a flowchart in FIG. 5. The information processing method determination unit 211 receives the processing status of terminal information in the information processing device 100 from the information processing unit 120 (step S11), and receives the information processing status/device status in the computing device 20 from the status receiving unit 220 (step S12). The received information is stored in the storage unit 212 (step S13), and the information processing status/device status required by the computing device 20 that is stored in the storage unit 212 is referenced and compared with the received information (steps S14 and S15). If the received information processing status/device status in the computing device 20 satisfies the information processing status/device status required by the computing device 20, the processing ends. If not, an information processing method that satisfies the information processing status/device status required by the computing device 20 is determined based on the information stored in the storage unit 212 (step S16). The determination result is stored in the storage unit 212, and is transmitted to the information processing unit 120 (step S17, S18).

As described above, with the information processing rule setting system according to this embodiment, a rule for processing information from a terminal 10 can be automatically created and set, and can also be modified and updated as necessary, such that the processing status required by the device that uses or processes the information from the terminal 10 is satisfied.

Examples of the information processing rule setting system according to the present invention will be described below.

### EXAMPLE 1

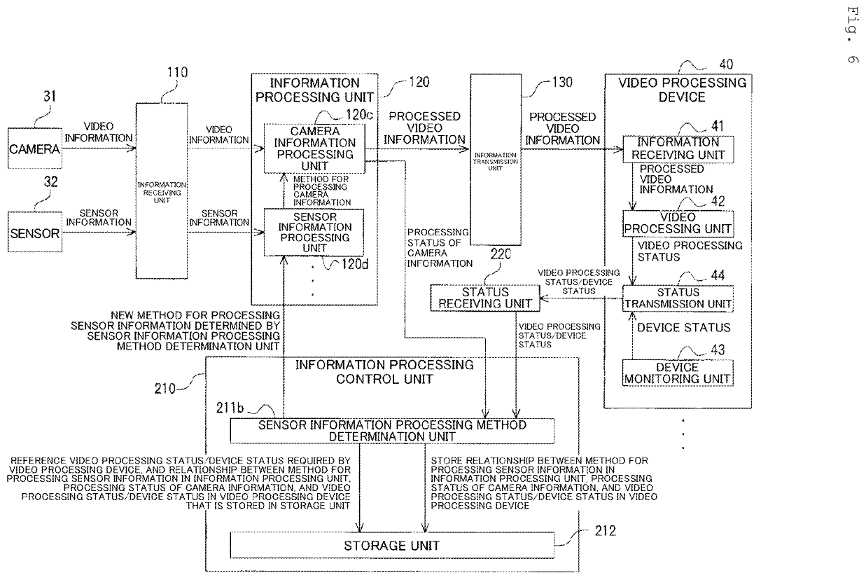

Example 1 is an example of applying the information processing rule setting system of the present invention to a system in which videos are transmitted from a camera to a video processing device. The system according to Example 1 will be described with reference to FIG. 6. FIG. 6 is a configuration diagram of the system according to Example 1.

In this system, information transmitted from a camera 31 is to be processed. The information processing device 100 according to Example 1 performs processing to discard video information or make video information transparent. A rule for processing the video information is created and set based on sensor information that is transmitted from a sensor 32, which is a terminal different from the camera 31 and is, for example, a velocity sensor attached to the camera 31. This sensor information is information indicating a state that affects an image-capturing state of video information. A video processing device 40 corresponds to the aforementioned computing device 20. The video processing device 40 includes an information receiving unit 41, an information processing unit 42, a device monitoring unit 43, and a status transmission unit 44.

A sensor information processing method determination unit 211b in the information processing control unit 210 determines a method for processing sensor information, i.e. creates the information processing rule, then transmits the determination result to a sensor information processing unit 120d in the information processing unit 120, and sets the information processing rule. A camera information processing unit 120c in the information processing unit 120 processes camera information based on a method for processing camera information presented by the sensor information processing unit 120d, i.e. the information processing rule.

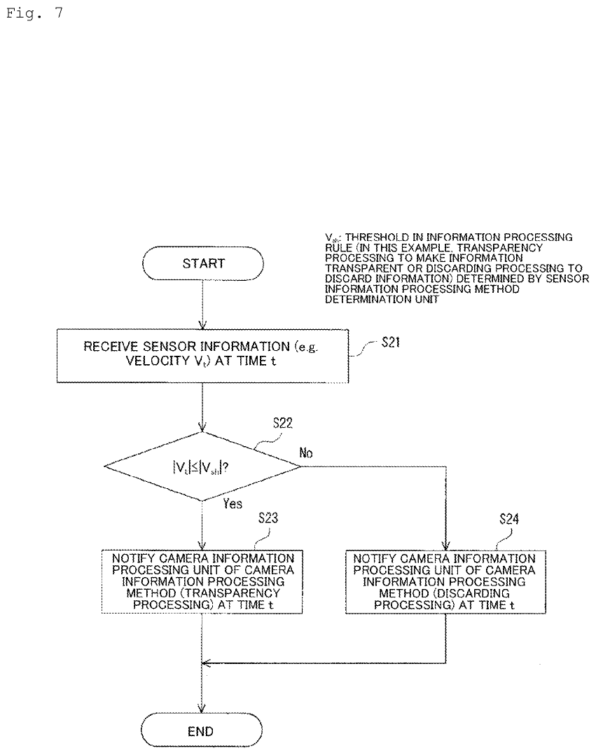

The method for processing sensor information determined in this example is a setting of a threshold Vₛₕ of velocity, as shown in a flowchart in FIG. 7. The information rule for performing transparency processing to make camera information transparent or discarding processing to discard camera information is created and set based on the relationship regarding which is larger or smaller between a velocity Vₜ at a time t that is received by the sensor information processing unit 120d and Vₛₕ (steps S21 to S24).

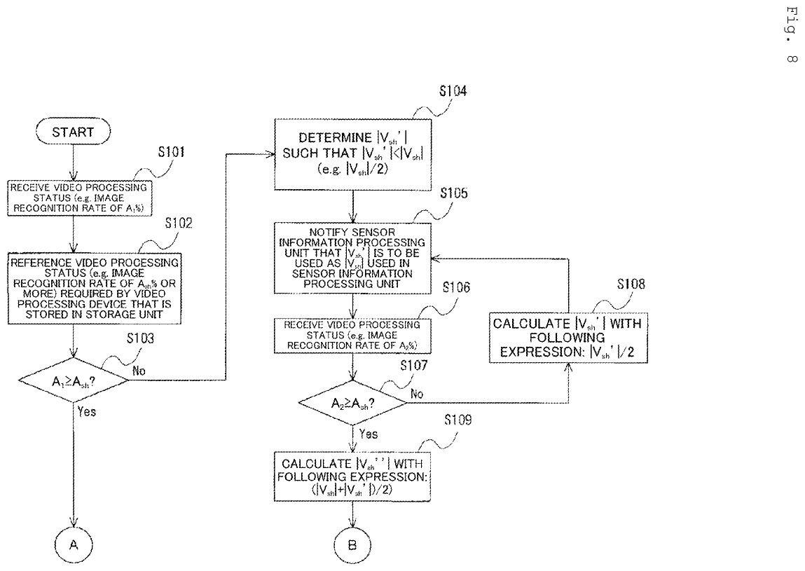

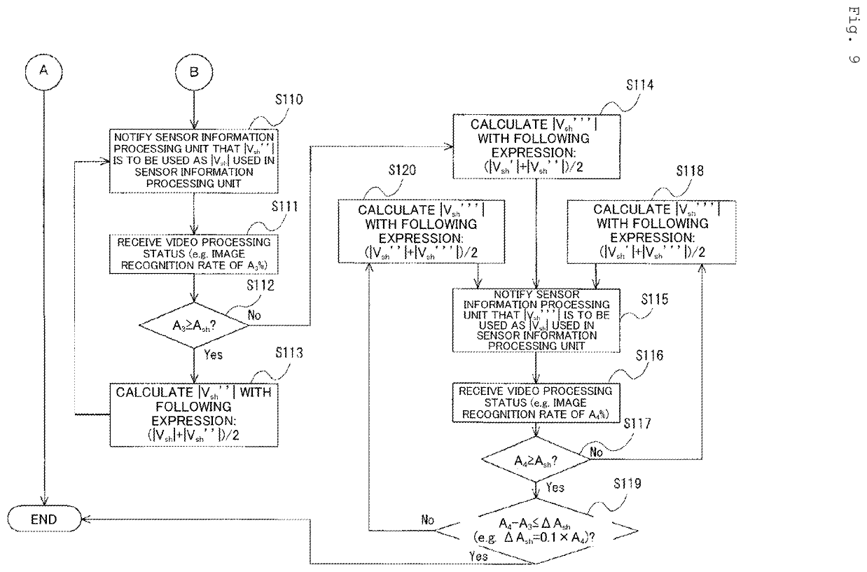

A flow of setting the information processing rule according to this example will be described with reference to a flowchart of the sensor information processing method determination unit 211b shown in FIGS. 8 and 9.

The sensor information processing method determination unit 211b receives the video processing status (e.g. image recognition rate of A₁ %) of the video processing device 40 (step S101), references the video processing status (e.g. image recognition rate of Aₛₕ % or more) required by the video processing device 40 stored in the storage unit 212, and compares the received video processing status with the required video processing status (steps S102 and S103). If the received video processing status satisfies the video processing status required by the video processing device 40, the processing ends. If not, a method for processing sensor information is determined, i.e. the processing transitions to a flow for setting Vₛₕ (steps S104 to S120).

In this example, it is estimated that a decrease in the image recognition rate (A %) is due to an excess of videos when the camera 31 is rapidly moving, and the information processing rule is corrected in a direction in which the amount of video is reduced when the camera 31 is rapidly moving. That is to say, |Vₛₕ′| is determined as |Vₛₕ|/2=|Vₛₕ′|, for example, such that |Vₛₕ′|<|Vₛₕ| (step S104), and the sensor information processing unit 120d is notified that |Vₛₕ′| is to be used as |Vₛₕ| used in the sensor information processing unit 120d (step S105).

Information processing is performed in the information processing unit 120 of the information processing device 100 based on the newly-determined |Vₛₕ|, and then a change occurs in the information processing. Thus, it is expected that the video processing status (e.g. image recognition rate of A₂ %) that is received next differs from the previously-received video processing status (e.g. image recognition rate of A₁ %).

Accordingly, A₂ is compared with Aₛₕ (steps S106 and S107), and if A₂ does not satisfy Aₛₕ either, |Vₛₕ′| is determined as |Vₛₕ′|/2 again (step S108), and the sensor information processing unit is notified that |Vₛₕ′| is to be used as |Vₛₕ| used in the sensor information processing unit 120d (step S105).

On the other hand, if A₂ satisfies Aₛₕ, it is assumed that |Vₛₕ′| is too small as |Vₛₕ| for satisfying Aₛₕ required by the video processing device 40. Then, |Vₛₕ| is increased until A does not satisfy Aₛₕ again. |Vₛₕ| that is used at a point at which A does not satisfy Aₛₕ again is considered as approaching an optimum value of |Vₛₕ| for satisfying Aₛₕ required by the video processing device 40. The optimum value here is |Vₛₕ| with which A satisfies Aₛₕ while avoiding an extreme decrease in the amount of video that occurs due to making |Vₛₕ| extremely small. Thus, |Vₛₕ| is reduced again, and |Vₛₕ| that is used at a point at which the change in A becomes smaller than or equal to a predetermined width (here, ΔAₛₕ) while A satisfies Aₛₕ is employed as the ultimate |Vₛₕ| to be used in the sensor information processing unit 120d, and the processing ends (steps S109 to S120).

As described above, in Example 1, a video acquired when the camera 31 rapidly moves has poor quality, and even if this video is transmitted to the video processing device 40, the video cannot be appropriately processed in the video processing device 40. Thus, the information processing rule can be automatically created, set, and updated that enables selective discarding of only video information that cannot be appropriately processed, i.e. video information that degrades the video processing status of the video processing device 40. Even when, as a result, a change occurs, e.g. the environment in which the camera 31 is installed changes, a state that satisfies the video processing status required by the video processing device 40 can be maintained.

### EXAMPLE 2

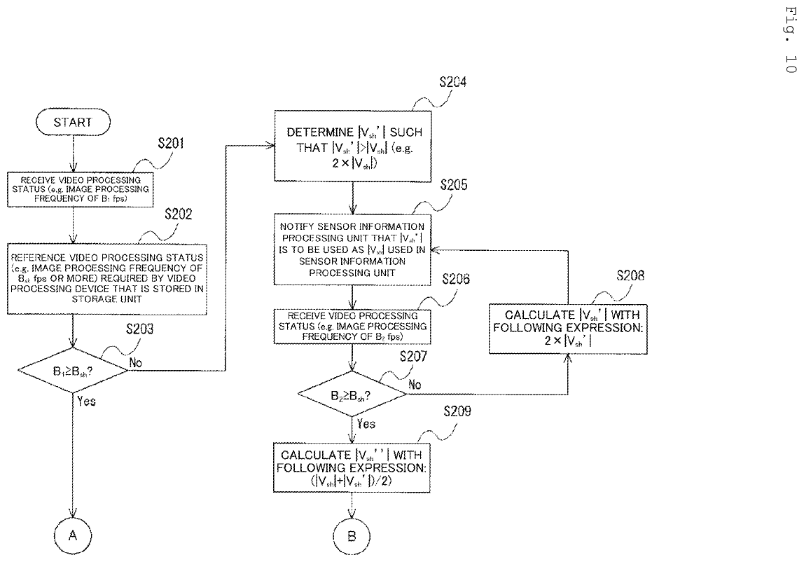

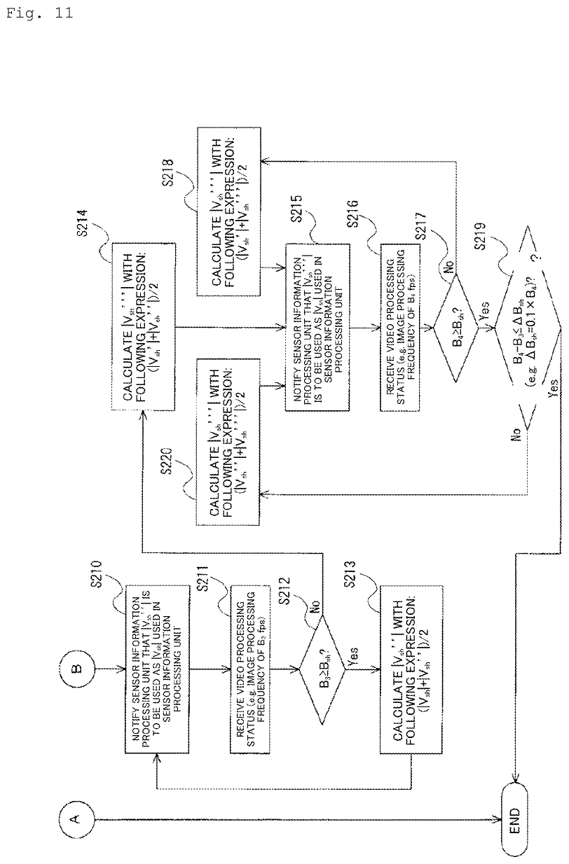

Example 2 is an example in which the information processing rule setting system of the present invention is applied to the same system as that in Example 1, and the video processing status required by the video processing device 40 is not an image recognition rate of Aₛₕ % but is an image processing frequency of Bₛₕ fps (frame per second). A flow of setting the information processing rule according to this example will be described with reference to a flowchart of the sensor information processing method determination unit 211b shown in FIGS. 10 and 11.

The sensor information processing method determination unit 211b receives the video processing status (e.g. image processing frequency of B₁ fps) of the video processing device 40 (step S201), references the video processing status (e.g. image processing frequency of Bₛₕ fps or more) required by the video processing device 40 that is stored in the storage unit 212, and compares the received video processing status with the required video processing status (steps S202 and S203). If the received video processing status satisfies the video processing status required by the video processing device 40, the processing ends. If not, a method for processing sensor information is determined, i.e. the processing transitions to a flow for setting Vₛₕ (steps S204 to S220).

In this example, it is estimated that a decrease in the image processing frequency (Bfps) is due to excessive discarding of video information, and the information processing rule is corrected in a direction in which the amount of video information discarded when the camera 31 is moving is reduced. That is to say, |Vₛₕ′| is made greater than |Vₛₕ|. For example, |Vₛₕ′| is determined as 2×|Vₛₕ|=|Vₛₕ′| (step S204), and the sensor information processing unit 120d is notified that |Vₛₕ′| is to bs used as |Vₛₕ| used in the sensor information processing unit 120d (step S205).

Information processing is performed based on the newly-determined |Vₛₕ| in the information processing unit 120 of the information processing device 100, and then a change occurs in the information processing. Thus, it is expected that the video processing status (e.g. image processing frequency of B₂ fps) that is received next differs from the previously-received video processing status (e.g. image processing frequency of B₁ fps).

Accordingly, B₂ is compared with Bₛₕ (steps S206 and S207), and if B₂ does not satisfy Bₛₕ either, |Vₛₕ′| is determined as 2×|Vₛₕ′| again (step S208), and the sensor information processing unit 120d is notified that |Vₛₕ′| is to be used as |Vₛₕ| used in the sensor information processing unit 120d (step S205).

On the other hand, if B₂ satisfies Bₛₕ, it is assumed that |Vₛₕ′| is too large as |Vₛₕ| for satisfying Bₛₕ required by the video processing device 40. Then, |Vₛₕ| is reduced until B does not satisfy Bₛₕ again. |Vₛₕ| that is used at a point at which B does not satisfy Bₛₕ again is considered as approaching an optimum value as |Vₛₕ| for satisfying Bₛₕ required by the video processing device 40. The optimum value here is |Vₛₕ| with which B satisfies Bₛₕ while avoiding an excess of videos that cannot be appropriately processed in the video processing device 40 when the camera is rapidly moving, the excess being caused due to setting a too large value as |Vₛₕ|. Thus, |Vₛₕ| is reduced again, and |Vₛₕ| that is used at a point when the change in B is smaller than or equal to a predetermined width (here, ΔBsh) while B satisfies Bₛₕ is employed as the ultimate |Vₛₕ| to be used in the sensor information processing unit 120d, and the processing ends (steps S209 to S220).

As described above, in Example 2, in the case where the video processing status of the video processing device 40 is degraded due to acquired videos being excessively discarded when the camera 31 moves, the information processing rule that satisfies the video processing status required by the video processing device 40 can be automatically created, set, and updated. Even when, as a result, a change occurs, e.g. the environment in which the camera 31 is installed changes, a state that satisfies the video processing status required by the video processing device 40 can be maintained.

### EXAMPLE 3

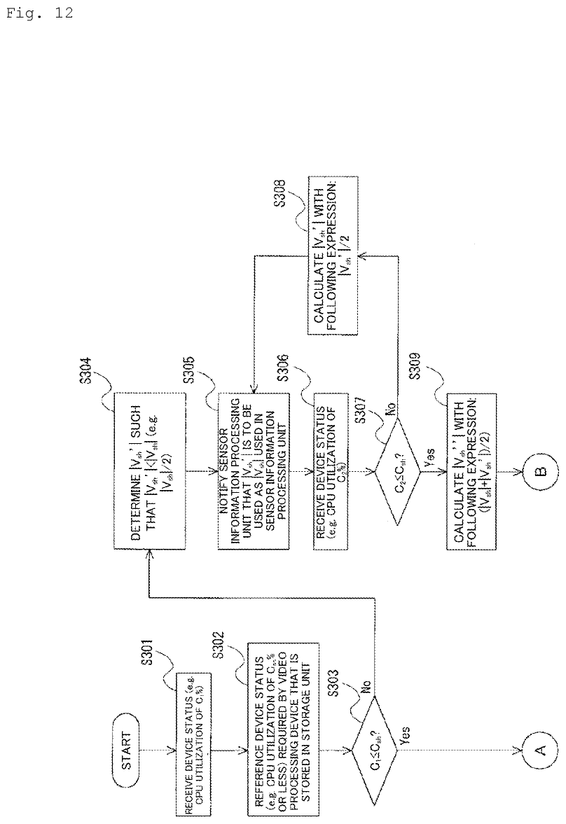

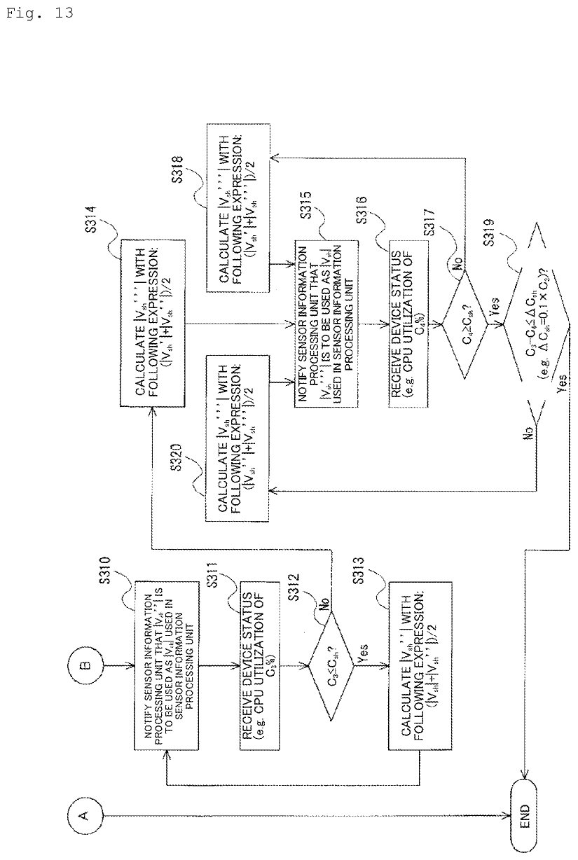

Example 3 is an example in which the information processing rule setting system of the present invention is applied to the same system as that in Example 1, and the device status required by the video processing device 40 is a CPU utilization of Cₛₕ %. A flow of setting the information processing rule according to this example will be described with reference to a flowchart of the sensor information processing method determination unit 211b shown in FIGS. 12 and 13.

The sensor information processing method determination unit 211b receives the device status (e.g. CPU utilization of C₁ %) of the video processing device 40 (step S301), references the device status (e.g. CPU utilization of Cₛₕ % or less) required by the video processing device 40 that is stored in the storage unit 212, and compares the received device status with the required device status (steps S302 and S303). If the received device status satisfies the device status required by the video processing device 40, the processing ends. If not, a method for processing sensor information is determined, i.e. the processing transitions to a flow for setting Vₛₕ (steps S304 to S320).

In this example, it is estimated that an increase in the CPU utilization (C %) is due to an excess of videos when the camera 31 is rapidly moving, and the information processing rule is corrected in a direction in which the amount of video is reduced when the camera 31 is rapidly moving. That is to say, |Vₛₕ′| is determined as |Vₛₕ|/2=|Vₛₕ′|, for example, such that |Vₛₕ′|<|Vₛₕ| (step S304). Then, the sensor information processing unit 120d is notified that |Vₛₕ′| is to be used as |Vₛₕ| used in the sensor information processing unit 120d (step S305).

Information processing is performed based on the newly-determined |Vₛₕ| in the information processing unit 120 of the information processing device 100. Since a change occurs in information processing, it is expected that the device status (e.g. CPU utilization of C₂ %) that is received next differs from the previously-received video processing status (e.g. CPU utilization of C₁ %).

Accordingly, C₂ is compared with Cₛₕ (steps S306 and S307) , and if C₂ does not satisfy Cₛₕ either, |Vₛₕ′| is determined as |Vₛₕ′|/2 again (step S308). Then, the sensor information processing unit 120d is notified that |Vₛₕ′| is to be used as |Vₛₕ| used in the sensor information processing unit 120d (step S305).

On the other hand, if C₂ satisfies Cₛₕ, it is assumed that |Vₛₕ′| is too small as |Vₛₕ| for satisfying Cₛₕ required by the video processing device 40. Then, |Vₛₕ| is increased until C does not satisfy Cₛₕ again. |Vₛₕ| that is used at a point at which C does not satisfy Cₛₕ again is considered as approaching an optimum value as |Vₛₕ| for satisfying Cₛₕ required by the video processing device 40. The optimum value here is |Vₛₕ| with which C satisfies Cₛₕ while avoiding an extreme decrease in the amount of video that occurs due to making |Vₛₕ| extremely small. Thus, |Vₛₕ| is reduced again, and |Vₛₕ| that is used at a point when the change in C is smaller than or equal to a predetermined width (here, ΔCₛₕ) while C satisfies Cₛₕ is employed as the ultimate |Vₛₕ| to be used in the sensor information processing unit 120d, and the processing ends (steps S309 to S320).

As described above, in Example 3, a video acquired when the camera 31 rapidly moves has poor quality and need not be transmitted to the video processing device 40. Thus, a packet processing rule can be automatically created, set, and updated that enables selective discarding of only video information that need not be transmitted to the video processing device 40, i.e. video information that degrades the device status of the video processing device 40. Even when, as a result, a change occurs, e.g. the environment in which the camera 31 is installed changes, a state that satisfies the video processing status required by the video processing device 40 can be maintained.

### EXAMPLE 4

Example 4 is an example in which the information processing rule setting system of the present invention is applied to the same system as that in Example 1, and the information processing rule is created using not only an information processing rule that is currently set, the video processing status of the video processing device 40, and the video processing status required by the video processing device 40, but also the processing status of camera information in the information processing device 100.

Furthermore, in this example, a process of obtaining an optimum |Vₛₕ| based on |Vₛₕ| that is initially set arbitrarily, i.e. a process of converging |Vₛₕ| as in Example 1 is not carried out, but information indicating the set |Vₛₕ|, the processing status of camera information in the information processing device 100, time-series data of the video processing status in the video processing device 40, and the relationship between a change in the processing status of camera information in the information processing device 100 and a change in the video processing status in the video processing device 40 when |Vₛₕ| is changed, is accumulated as training data for machine learning, and a mechanism, e.g. a neural network that is capable of estimating |Vₛₕ| that satisfies the video processing status required by the video processing device 40 is created and used.

The system in Example 1 has characteristics in that video information transmitted by the camera 31 is processed using information from a terminal different from the camera 31, such as the sensor 32. In this example, however, the neural network is developed, for example, using, as training data, not only findings regarding the influence that the method for processing information from a terminal other than the camera 31 placed on the video processing status in the video processing device 40, but also finding regarding the influence that it placed on the processing status itself of camera information. This configuration makes it possible to more quickly and accurately create the method for processing terminal information that is characteristic of this system, i.e. an information processing rule, which is |Vₛₕ|, to be used in the information processing device 100 in this system in order to satisfy the video processing status required by the video processing device 40, than in Example 1.

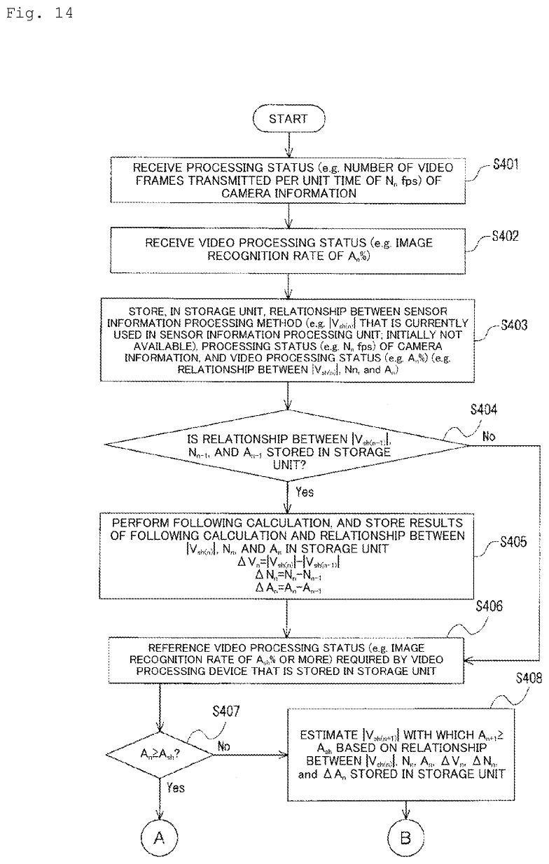

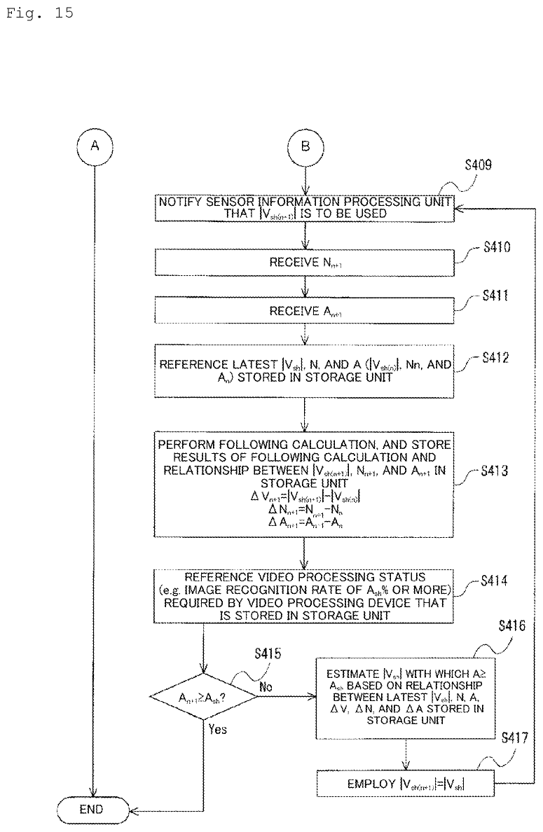

Since training data used in this neural network continues to be accumulated as long as the information processing rule setting system is used, the accuracy and quickness in creation of the information processing rule, which is |Vₛₕ|, to be used in the information processing device 100 improve in accordance with the development of the neural network. A flow of setting the information processing rule according to this example will be described with reference to a flowchart of the sensor information processing method determination unit shown in FIGS. 14 and 15.

The sensor information processing method determination unit 211b receives the processing status (e.g. the number of video frames transmitted per unit time of Nₙ fps) of camera information (step S401), and also receives the video processing status (e.g. image recognition rate of A₁ %) of the video processing device 40 (step S402). Next, the relationship between the sensor information processing method (e.g. |Vₛₕ₍ₙ₎| that is currently used in the sensor information processing unit; initially not available), the processing status (e.g. Nₙ fps) of camera information, and the video processing status (e.g. Aₙ %) (e.g. relationship between |Vₛₕ₍ₙ₎|, Nₙ, and Aₙ) is stored in the storage unit 212 (step S403). |Vₛₕ₍ₙ₎|, Nₙ, and Aₙ here may be obtained by picking up any |Vₛₕ₍ₙ₎|, Nₙ, and Aₙ at a certain time, or may be an average of |Vₛₕ₍ₙ₎|, Nₙ, and Aₙ per certain unit time.

When the relationship between |Vₛₕ₍ₙ₎|, Nₙ, and Aₙ is stored in the storage unit 212, if the relationship between |Vₛₕ|, N, and A (e.g. relationship between |Vₛₕ₍ₙ₋₁₎|, Nₙ₋₁, and Aₙ₋₁) is already stored, the following calculation is performed.

ΔVₙ=|Vₛₕ₍ₙ₎|−Vₛₕ₍ₙ₋₁₎|

ΔNₙ=Nₙ−Nₙ₋₁

ΔAₙ=Aₙ−Aₙ₋₁

Then, the results of the above calculation and the relationship between |Vₛₕ₍ₙ₎|, Nₙ, and Aₙ are stored in the storage unit (steps S404 and S405). Information stored in the storage unit 212 is used in the learning of the neural network to estimate the information processing rule, which is |Vₛₕ|.

Next, the received video processing status: Aₙ % of the video processing device 40 and the video processing status (e.g. image recognition rate of Aₛₕ % or more) required by the video processing device 40 that is stored in the storage unit 212 are referenced and compared (steps S406 and S407). If the received video processing status satisfies the video processing status required by the video processing device 40, the processing ends. If not, a method for processing sensor information is determined, i.e. the processing transitions to a flow for setting Vₛₕ (S408 to S417).

In this example, Vₛₕ is estimated using the neural network that has been developed using information stored in the storage unit 212 as training data. |Vₛₕ₍ₙ₊₁₎| with which Aₙ₊₁≥Aₛₕ is estimated based on the relationship between |Vₛₕ₍ₙ₎|, Nₙ, Aₙ, ΔVₙ, ΔNₙ, and ΔAₙ that is stored in the storage unit 212 (step S408), and the sensor information processing unit 120d is notified that |Vₛₕ₍ₙ₊₁₎| is to be used (step S409). Nₙ₊₁ and Aₙ₊₁ that are received after setting |Vₛₕ₍ₙ₊₁₎| as a new information processing rule is stored in the storage unit 212, together with the results of the following calculation performed with reference to |Vₛₕ₍ₙ₋₁₎| and the latest |Vₛₕ|, N, and A (|Vₛₕ₍ₙ₎|, Nₙ, and Aₙ) that are stored in the storage unit 212 (step S410 to S413).

ΔVₙ₊₁=|Vₛₕ₍ₙ₊₁₎|−Vₛₕ₍ₙ₎|

ΔNₙ₊₁=Nₙ₊₁−Nₙ

ΔAₙ₊₁=Aₙ₊₁−Aₙ

Aₙ₊₁ is compared with Aₛₕ (steps S414 to S415). If Aₙ₊₁ satisfies Aₛₕ, the processing ends. If not, |Vₛₕ₍ₙ₊₁₎| with which Aₙ₊₁>Aₛₕ is estimated again (steps S416 and S417), and the sensor information processing unit is notified that |Vₛₕ₍ₙ₊₁₎| is to be used (step S409).

As described above, the information processing rule that satisfies the video processing status required by the video processing device 40 can be automatically created, set, and updated based on the relationship between the set information processing rule, the actual processing status of camera information, and the video processing status in the video processing device 40, as well as the video processing status required by the video processing device 40.

In addition, learning of the neural network that creates the information processing rule is continuously carried out even when the information processing rule is not updated, and thus, the speed and the accuracy of creation of an appropriate information processing rule continues to improve. The developed neural network can also be used when applying the present invention to other similar systems, and in this case, the information processing rule can be quickly and accurately created from the initial stage. Needless to say, some problems may occur at the initial stage in the speed and accuracy of creation of the information processing rule unless the neural network is applied to a completely identical system. However, since learning is continuously carried out, a neural network that is suitable for the system to which it is applied is created.

### EXAMPLE 5

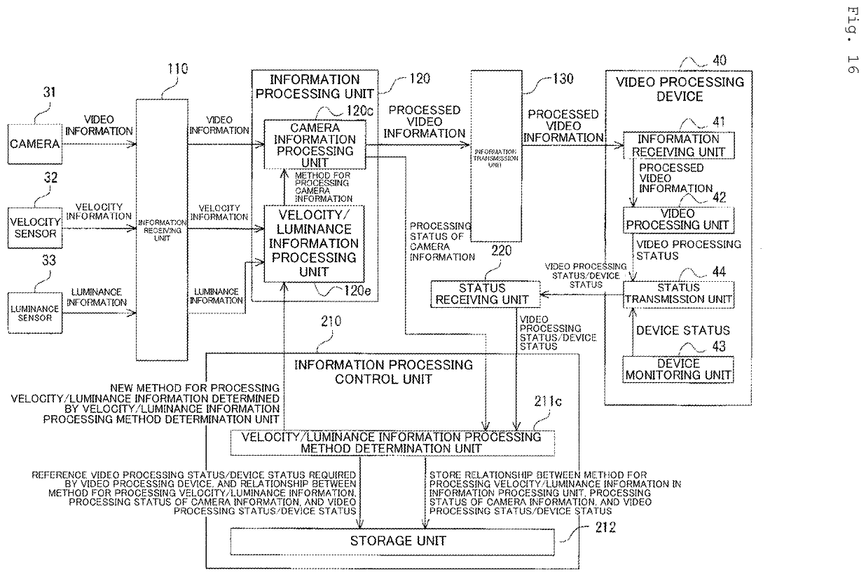

Example 5 is an example of applying the information processing rule setting system of the present invention to a system in which videos are transmitted from the camera 31 to the video processing device 40, similar to Example 1. A difference between this example and the above-described Example 1 lies in that two types of sensors to be used to create a rule for processing video information are provided, as shown in a functional block diagram of this example in FIG. 16. That is to say, in this example, the rule for processing video information is created and set based on a combination of velocity information that is transmitted from a velocity sensor 32 and luminance information transmitted from a luminance sensor 33, the velocity sensor 32 and the luminance sensor 33 being terminals different from the camera 31 and are attached thereto. Each of the velocity information and luminance information is information indicating a state that affects an image-capturing state in video information.

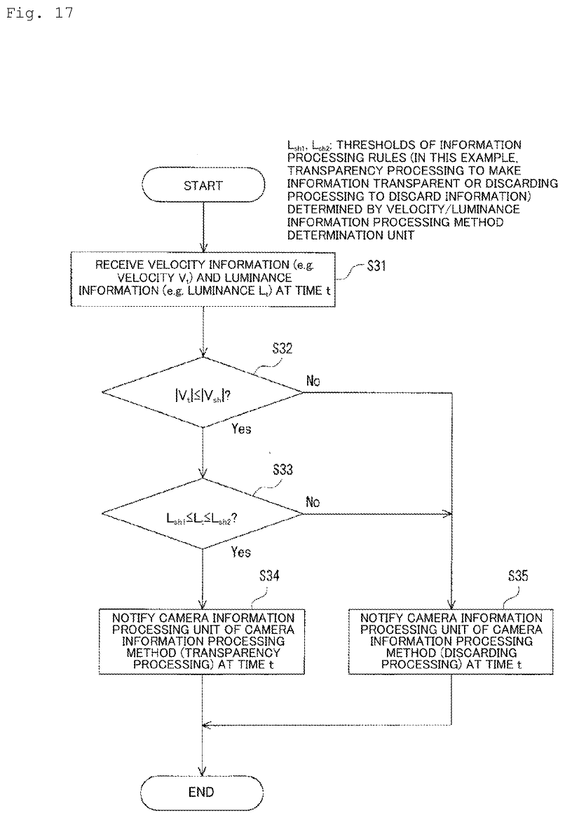

A method for processing velocity/luminance information determined in this example is a setting of a threshold Vₛₕ of velocity and thresholds Lₛₕ₁ and Lₛₕ₂ of luminance, as shown in a flowchart in FIG. 17. An information processing rule for transparency performing processing to make camera information transparent or discarding processing to discard camera information is created and set based on the relationship regarding which is larger or smaller between a velocity Vₜ and Vₛₕ and the relationship regarding which is larger or smaller between a luminance Lₜ, and Lₛₕ₁ and Lₛₕ₂, at a time t at which a velocity/luminance information processing unit 120e received the velocity Vₜ and the luminance Lₜ (steps S31 to S35).

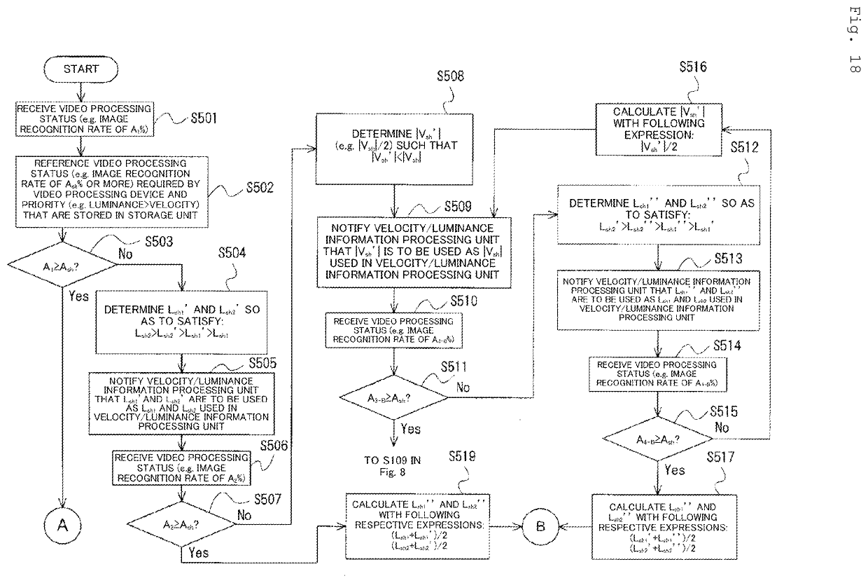

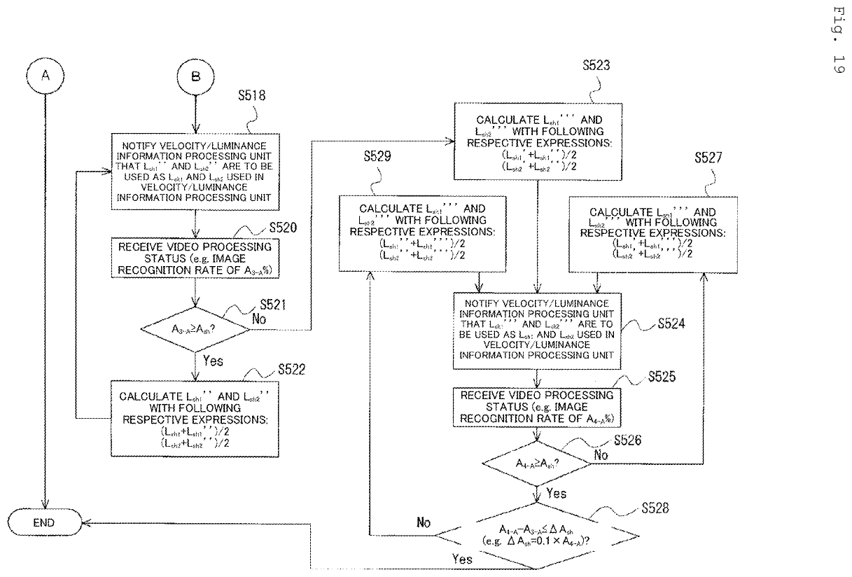

A flow of setting the information processing rule according to this example will be described with reference to a flowchart of a velocity/luminance information processing method determination unit 211c shown in FIGS. 18 and 19.

The velocity/luminance information processing method determination unit 211c receives the video processing status (e.g. image recognition rate of A₁ %) of the video processing device 40 (step S501), references the video processing status (e.g. image recognition rate of Aₛₕ % or more) required by the video processing device 40 that is stored in the storage unit 212, and compares the received video processing status with the required video processing status (steps S502 to S503). Also, at this time, the priority regarding which of luminance and velocity is to preferentially processed (here, luminance>velocity) is also referenced. If the received video processing status satisfies the video processing status required by the video processing device 40, the processing ends. If not, a method for processing velocity/luminance information is determined, i.e. the processing transitions to a flow for setting Vₛₕ, Lₛₕ₁, and Lₛₕ₂ (steps S504 to S529).

In this example, it is estimated that a decrease in the image recognition rate (A %) is due to an excess of videos when the camera 31 is rapidly moving, or an excess of videos when the camera 31 is installed at a dark place or a bright place. Here, since the processing priority of luminance is higher than that of velocity, firstly, the information processing rule is corrected in a direction in which the amount of video when the camera is installed at a dark place or a bright place is reduced, i.e. Lₛₕ₁′ and Lₛₕ₂′ are determined such that Lₛₕ₂>Lₛₕ₂′>Lₛₕ₁′>Lₛₕ₁ (step S505), and the velocity/luminance information processing unit 120e is notified that Lₛₕ₁′ and Lₛₕ₂′ are to be used as Lₛₕ₁ and Lₛₕ₂ used in the velocity/luminance information processing unit 120e (step S506).

A₂ received after setting the new information processing rule is compared with Aₛₕ, and if A₂ does not satisfy Aₛₕ either, Vₛₕ is modified similarly to Example 1 (steps S507 to S509). A_{3-B} received after setting the new information processing rule is compared with Aₛₕ, and if A_{3-B} satisfies Aₛₕ, Vₛₕ is converged in the same manner as in Example 1 (steps S510 to S511, step S109 and subsequent steps in FIG. 8). If A_{3-B} does not Aₛₕ either, the method for processing luminance information is modified again (steps 512 to S518). If A₂ satisfies Aₛₕ, Lₛₕ₁ and Lₛₕ₂ are converged in the same manner as in Example 1 (steps S518 to S529).

As described above, in this example, videos acquired when the camera 31 rapidly moves and videos acquired when the camera 31 is installed at a dark place or a bright place have poor quality, and even if such videos are transmitted to the video processing device 40, the videos cannot be appropriately processed in the video processing device 40. Thus, an information processing rule can be automatically created, set, and updated that enables selective discarding of only video information that cannot be appropriately processed, i.e. video information that degrades the video processing status of the video processing device 40. Even when, as a result, a change occurs, e.g. the environment in which the camera 31 is installed changes, a state that satisfies the video processing status required by the video processing device 40 can be maintained.

### EXAMPLE 6

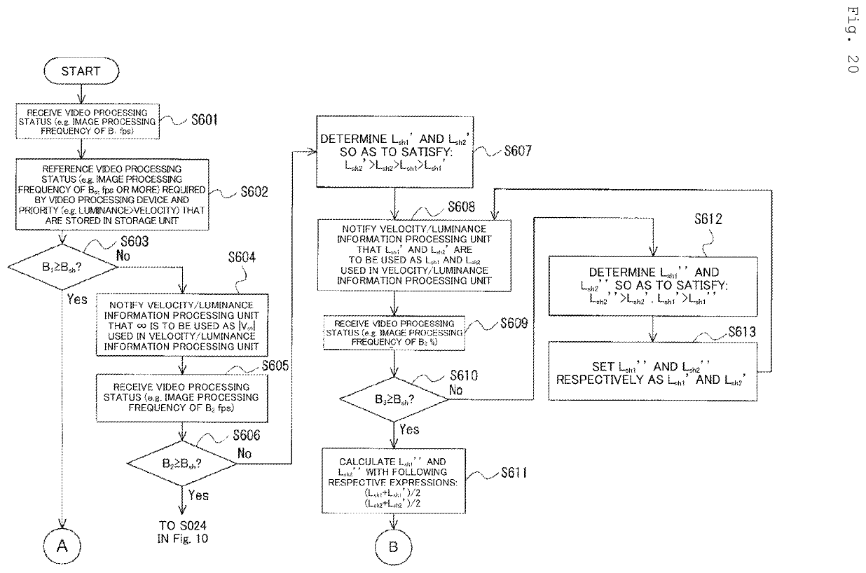

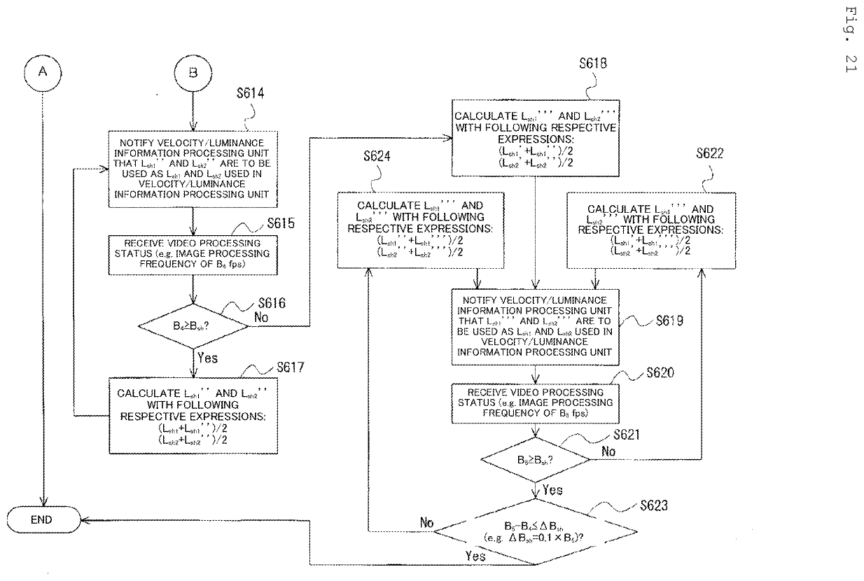

Example 6 is an example similar to Example 5 in which the information processing rule setting system of the present invention is applied to a system in which videos are transmitted from the camera 31 to the video processing device 40, and the video processing status required by the video processing device 40 is not an image recognition rate of Aₛₕ % but an image processing frequency of Bₛₕ fps. A flow of setting the information processing rule according to this example will be described with reference to the flowchart of the velocity/luminance information processing method determination unit 211c shown in FIGS. 20 and 21.

The velocity/luminance information processing method determination unit 211c receives the video processing status (e.g. image processing frequency of B₁ fps) of the video processing device 40 (step S601), references the video processing status (e.g. image processing frequency of Bₛₕ fps or more) required by the video processing device 40 that is stored in the storage unit 212, and compares the received video processing status with the required video processing status (steps S602 and S603). Also, at this time, the priority regarding which of luminance and velocity is to be preferentially processed (here, luminance>velocity) is also referenced. If the received video processing status satisfies the video processing status required by the video processing device 40, the processing ends. If not, a method for processing velocity/luminance information is determined, i.e. the processing transitions to a flow for setting Vₛₕ, Lₛₕ₁, and Lₛₕ₂ (steps S604 to S624).

In the present example, it is estimated that a decrease in the image processing frequency (B fps) is due to excessive discarding of camera information. Here, since the processing priority of luminance is higher than that of velocity, firstly, the information processing rule is corrected such that videos are not discarded when the camera 31 is moving, i.e. the velocity/luminance information processing unit 120e is notified that ∞ is to be used as |Vₛₕ| used in the velocity/luminance information processing unit 120e (step S604). B₂ received after setting the new information processing rule is compared with Bₛₕ, and if B₂ satisfies Bₛₕ, Vₛₕ is converged in the same manner as in Example 2 (steps S605 and S606, step S204 and subsequent steps in FIG. 10). If B₂ does not satisfy Bₛₕ, Lₛₕ₁′ and L_{sh2′} are determined such that Lₛₕ₂′>Lₛₕ₂>Lₛₕ₁>Lₛₕ₁′ and the information processing rule is corrected in a direction in which the amount of video discarded when the camera 31 is installed at a dark place or a bright place is reduced (steps S607 and S608). Thereafter, Lₛₕ₁ and Lₛₕ₂ are converged in the same manner as in Example 2 (steps S609 to S624).

As described above, in this example, in the case where the video processing status of the video processing device 40 is degraded due to videos acquired when the camera 31 moves and videos acquired when the camera 31 is installed at a dark place or a bright place being excessively discarded, an image processing rule that satisfies the video processing status required by the video processing device 40 can be automatically created, set, and updated. Even when, as a result, a change occurs, e.g. the environment in which the camera 31 is installed changes, a state that satisfies the video processing status required by the video processing device 40 can be maintained.

### EXAMPLE 7

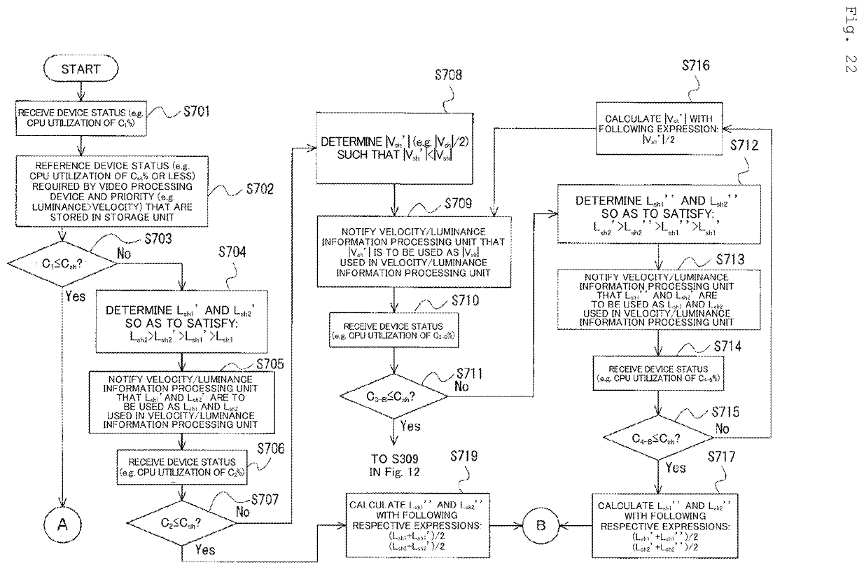

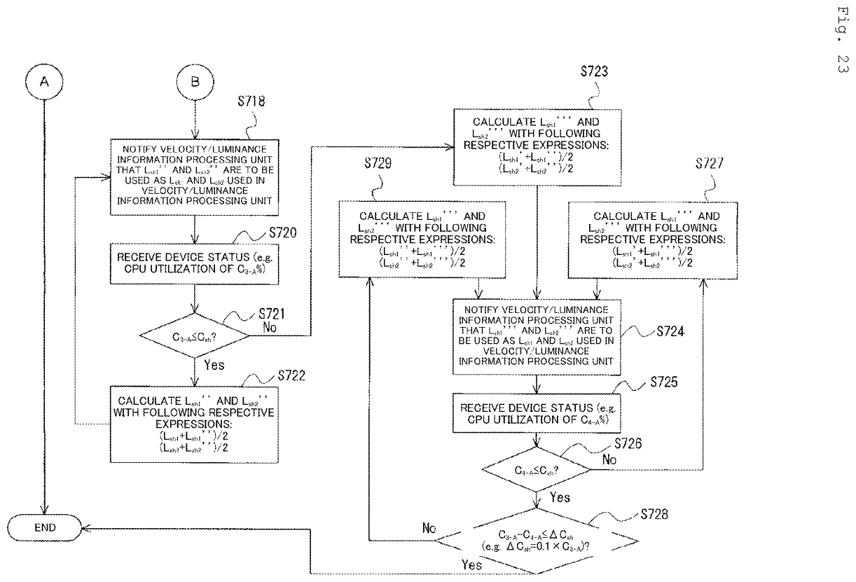

Example 7 is an example in which the information processing rule setting system of the present invention is applied to the same system as that in Example 5, and the device status required by the video processing device 40 is a CPU utilization of Cₛₕ %. A flow of setting the information processing rule according to this example will be described with reference to a flowchart of the velocity/luminance information processing method determination unit 211c shown in FIGS. 22 and 23.

The velocity/luminance information processing method determination unit 211c receives the device status (e.g. CPU utilization of C₁ %) of the video processing device 40 (step S701), references the device status (e.g. CPU utilization of Cₛₕ% or less) required by the video processing device 40 that is stored in the storage unit 212, and compares the received device status with the required video status (steps S702 and S703). Also, at this time, the priority regarding which of luminance and velocity is to be preferentially processed (here, luminance>velocity) is also referenced. If the received video processing status satisfies the video processing status required by the video processing device 40, the processing ends. If not, a method for processing velocity/luminance information is determined, i.e. the processing transitions to a flow for setting Vₛₕ, Lₛₕ₁, and Lₛₕ₂ (steps S704 to S729).

In this example, it is estimated that an increase in the CPU utilization (C %) is due to an excess of videos when the camera 31 is rapidly moving, or an excess of videos when the camera is installed at a dark place or a bright place. Here, since the processing priority of luminance is higher than that of velocity, firstly, the information processing rule is corrected in a direction in which the amount of video when the camera 31 is installed at a dark place or a bright place is reduced, i.e. Lₛₕ₁′ and Lₛₕ₂′ are determined such that Lₛₕ₂>Lₛₕ₂′>Lₛₕ₁′>Lₛₕ₁, and the velocity/luminance information processing unit 120e is notified that Lₛₕ₁′ and Lₛₕ₂′ are to be used as Lₛₕ₁ and Lₛₕ₂ used in the velocity/luminance information processing unit 120e (steps S704 and S705).

C₂ received after setting a new packet processing rule is compared with Cₛₕ (step S706 and S707), and if C₂ does not satisfy Cₛₕ either, Vₛₕ is modified in the same manner as in Example 1 (steps S708 and S709). C_{3-B} received after setting the new information processing rule is compared with Cₛₕ (step S710 and S711) , and if C_{3-B} does not satisfy Cₛₕ either, Vₛₕ is converged in the same manner as in Example 1 (step S309 and subsequent steps in FIG. 12). If C_{3-B} does not satisfy Cₛₕ either, the method for processing luminance information is modified again (steps S712 and S713). If C₂ satisfies Cₛₕ, Lₛₕ₁ and Lₛₕ₂ are converged in the same manner as in Example 1 (steps S718 to S729).

As described above, in this example, videos acquired when the camera 31 rapidly moves and videos acquired when the camera 31 is installed at a dark place or a bright place have poor quality and need not be transmitted to the video processing device 40. Thus, an information processing rule can be automatically created, set, and updated that enables selective discarding of only video information that need not be transmitted to the video processing device 40, i.e. video information that degrades the device status of the video processing device 40. Even when, as a result, a change occurs, e.g. the environment in which the camera 31 is installed changes, a state that satisfies the video processing status required by the video processing device 40 can be maintained.

### EXAMPLE 8

Example 8 is an example in which the information processing rule setting system of the present invention is applied to the same system as that in Example 5, and an information processing rule is created using not only an information processing rule that is currently set, the video processing status of the video processing device 40, and the video processing status required by the video processing device 40, but also the processing status of camera information in the information processing device 100, similarly to Example 4.

In this example, a process of obtaining optimum |Vₛₕ|, Lₛₕ₁, and Lₛₕ₂ based on |Vₛₕ|, Lₛₕ₁, and Lₛₕ₂ that are initially set arbitrarily, i.e. a process of converging |Vₛₕ|, Lₛₕ₁, and Lₛₕ₂ as in Example 5 is not carried out, but information indicating |Vₛₕ|, Lₛₕ₁, Lₛₕ₂, the processing status of camera information in the information processing device 100, time-series data of the video processing status in the video processing device 40, and the relationship between a change in the processing status of camera information in the information processing device 100 and a change in the video processing status in the video processing device 40 when |Vₛₕ|, Lₛₕ₁, and Lₛₕ₂ are changed, is accumulated as training data for machine learning, and a mechanism, e.g. a neural network that is capable of estimating |Vₛₕ|, Lₛₕ₁, and Lₛₕ₂ that satisfy the video processing status required by the video processing device 40 is created and used.

The system in Example 5 has characteristics in that video information transmitted by the camera 31 is processed using information from terminals different from the camera 31, such as the velocity sensor 32 and the luminance sensor 33. In this example, not only findings regarding the influence that the method for processing information from terminals different from the camera 31 placed on the video processing status of the video processing device 40, but also findings regarding the influence that it placed on the processing status itself of camera information are used as training data. By developing, for example, the neural network using the aforementioned training data, a method for processing terminal information that is characteristic of this system, i.e. information processing rules, which are |Vₛₕ|, Lₛₕ₁, and Lₛₕ₂, to be used in the information processing device 100 in this system in order to satisfy the video processing status required by the video processing device 40 can be created more quickly and accurately than in Example 5.

Since training data used in this neural network continues to be accumulated as long as the information processing rule setting system is used, the accuracy and quickness in creation of the information processing rules, which are |Vₛₕ|, Lₛₕ₁, and Lₛₕ₂, to be used in the information processing device 100 improve in accordance with the development of the neural network.

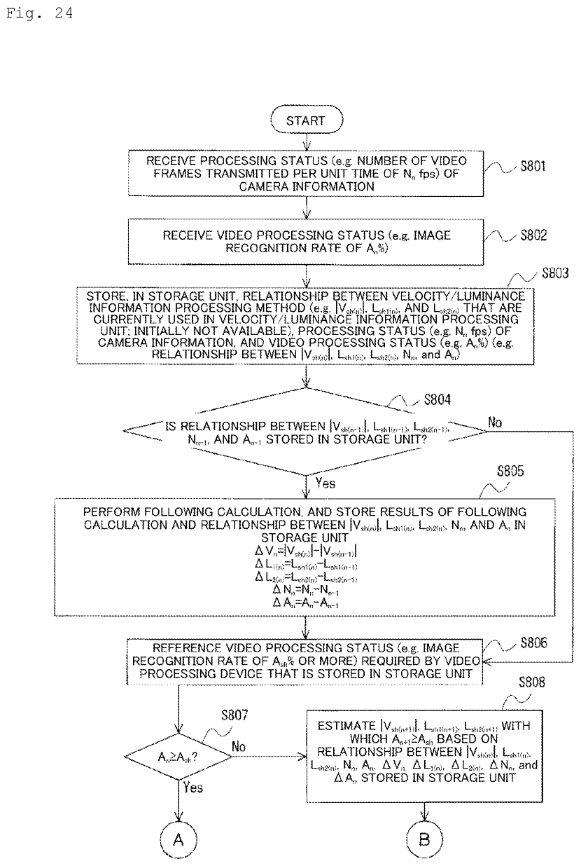

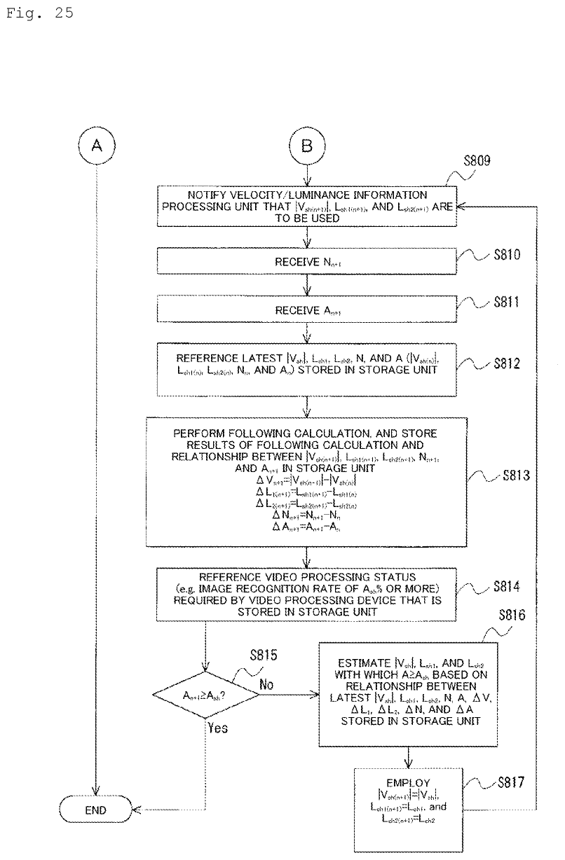

A flow of setting the information processing rule according to this example will be described with reference to a flowchart of the velocity/luminance information processing method determination unit 211c shown in FIGS. 24 and 25.

The velocity/luminance information processing method determination unit 211c receives the processing status (e.g. the number of video frames transmitted per unit time of Nₙ fps) of camera information (step S801). Further, the velocity/luminance information processing method determination unit 211c receives the video processing status of the video processing device 40 (e.g. image recognition rate of A₁ %) (step S802). Next, the velocity/luminance information processing method determination unit 211c stores, in the storage unit 212, the relationship between the velocity/luminance information processing method (e.g. |Vₛₕ₍ₙ₎|, Lₛₕ₁₍ₙ₎, and Lₛₕ₂₍ₙ₎ that are currently used in the velocity/luminance information processing unit 120e; initially not available), the processing status (e.g. Nₙ fps) of camera information, and the video processing status (e.g. Aₙ %) (e.g. relationship between |Vₛₕ₍ₙ₎|, Lₛₕ₁₍ₙ₎, and Lₛₕ₂₍ₙ₎, Nₙ, and Aₙ) (step S803).

|Vₛₕ₍ₙ₎|, Lₛₕ₁₍ₙ₎, and Lₛₕ₂₍ₙ₎, Nₙ, and Aₙ here may be obtained by picking up any |Vₛₕ₍ₙ₎|, Lₛₕ₁₍ₙ₎, and Lₛₕ₂₍ₙ₎, Nₙ, and Aₙ at a certain time, or an average of |Vₛₕ₍ₙ₎|, Lₛₕ₁₍ₙ₎, and Lₛₕ₂₍ₙ₎, Nₙ, and Aₙ per certain unit time may be used as |Vₛₕ₍ₙ₎|, Lₛₕ₁₍ₙ₎, and Lₛₕ₂₍ₙ₎, Nₙ, and Aₙ. When the relationship between |Vₛₕ₍ₙ₎|, Lₛₕ₁₍ₙ₎, and Lₛₕ₂₍ₙ₎, Nₙ, and Aₙ is stored in the storage unit 212, if the relationship between |Vₛₕ|, Lₛₕ₁, Lₛₕ₂, N, and A (e.g. relationship between |Vₛₕ₍ₙ₋₁₎|, Lₛₕ₁₍ₙ₋₁₎, Lₛₕ₂₍ₙ₋₁₎, Nₙ₋₁, and Aₙ₋₁) is already stored, the following calculation is performed.

ΔVₙ=|Vₛₕ₍ₙ₎|−Vₛₕ₍ₙ₋₁₎|

ΔL₁₍ₙ₎=Lₛₕ₁₍ₙ₎−Lₛₕ₁₍ₙ₋₁₎

ΔL₂₍ₙ₎=Lₛₕ₂₍ₙ₎−Lₛₕ₂₍ₙ₋₁₎

ΔNₙ₊₁=Nₙ₊₁−Nₙ

ΔAₙ₊₁=Aₙ₊₁−Aₙ

Then, the results of the above calculation and the relationship between |Vₛₕ₍ₙ₎|, Lₛₕ₁₍ₙ₎, and Lₛₕ₂₍ₙ₎, Nₙ, and Aₙ are stored in the storage unit 212 (steps S804 and S805). Information stored in the storage unit 212 is used in the learning of the neural network to estimate the information processing rules, which are |Vₛₕ|, Lₛₕ₁ and Lₛₕ₂.

Next, the velocity/luminance information processing method determination unit 211c references the received video processing status: Aₙ % of the video processing device 40 and the video processing status (e.g. image recognition rate of Aₛₕ % or more) required by the video processing device 40 that is stored in the storage unit 212, and compares the received video processing status with the required video processing status (steps S806 and S807). If the received video processing status satisfies the video processing status required by the video processing device 40, the processing ends. If not, a method for processing velocity/luminance information is determined, i.e. the processing transitions to a flow for setting Vₛₕ, Lₛₕ₁₍ₙ₎, and Lₛₕ₂₍ₙ₎ (steps S808 to S817).

In this example, Vₛₕ, Lₛₕ₁₍ₙ₎, and Lₛₕ₂₍ₙ₎ are estimated using the neural network that has been developed using information stored in the storage unit 212 as training data. Vₛₕ|, Lₛₕ₁, and Lₛₕ₂ with which A≥Aₛₕ is estimated based on the latest relationship between |Vₛₕ|, Lₛₕ₁, and Lₛₕ₂ and N, A, ΔV, ΔL₁, ΔL₂, ΔN, and ΔA stored in the storage unit 212, and the velocity/luminance information processing unit 120e is notified that the estimated Vₛₕ, Lₛₕ₁, and Lₛₕ₂ are to be used (steps S808 and S809).

Nₙ₊₁ and Aₙ₊₁ that are received after setting the new packet processing rules |Vₛₕ₍ₙ₊₁₎|, Lₛₕ₁₍ₙ₊₁₎, and Lₛₕ₂₍ₙ₊₁₎) are stored in the storage unit 212, together with the results of the following calculation performed with reference to |Vₛₕ₍ₙ₊₁₎|, Lₛₕ₁₍ₙ₊₁₎, and Lₛₕ₂₍ₙ₊₁₎, as well as the latest |Vₛₕ|, Lₛₕ₁, Lₛₕ₂, N, and A (|Vₛₕ₍ₙ₎|, Lₛₕ₁₍ₙ₎, Lₛₕ₂₍ₙ₎, Nₙ, and Aₙ) that are stored in the storage unit (step S810 to S813).

ΔVₙ₊₁=|Vₛₕ₍ₙ₋₁₎|−Vₛₕ₍ₙ₎|

ΔL₁₍ₙ₊₁₎=Lₛₕ₁₍ₙ₊₁₎−Lₛₕ₁₍ₙ₎

ΔL₂₍ₙ₊₁₎=Lₛₕ₂₍ₙ₊₁₎−Lₛₕ₂₍ₙ₎

ΔNₙ₊₁=Nₙ₊₁−Nₙ

ΔAₙ₊₁=Aₙ₊₁−Aₙ

Aₙ₊₁ is compared with Aₛₕ (steps S814 to S815). If Aₙ₊₁ satisfies Aₛₕ, the processing ends, If not, |Vₛₕ₍ₙ₊₁₎|, Lₛₕ₁₍ₙ₊₁₎, and Lₛₕ₂₍ₙ₊₁₎ which Aₙ₊₁≥Aₛₕ is estimated again, and the velocity/luminance information processing unit 120e is notified that |Vₛₕ₍ₙ₊₁₎|, Lₛₕ₁₍ₙ₊₁₎, and Lₛₕ₂₍ₙ₊₁₎ are to be used (steps S816, S817, and S809).

As described above, an information processing rule that satisfies the video processing status required by the video processing device 40 can be automatically created, set, and updated based on the relationship between a set information processing rule, the actual processing status of camera information, and the video processing status in the video processing device 40, as well as the video processing status required by the video processing device 40.

In addition, learning of the neural network that creates the information processing rule is continuously carried out even when the information processing rule is not updated, and thus, the speed and the accuracy of creation of an appropriate information processing rule continues to improve. The developed neural network can also be used when applying the present invention to other similar systems, and in this case, the information processing rule can be quickly and accurately created from the initial stage. Needless to say, some problems may occur at the initial stage in the speed and accuracy of creation of the information processing rule unless the neural network is applied to a completely identical system. However, since learning is continuously carried out, a neural network that is suitable for the system to which it is applied is created.

Although an embodiment and examples of the present invention has been described above in detail, the present invention is not limited thereto. For example, in the above examples, the first terminal 10-1 is a camera 31 that transmits video information, and the second terminal 10-2 includes the sensors 32 and 33 that transmit velocity information and trajectory information that is information indicating information which affects the image-capturing state of video information. However, the present invention is not limited thereto and may be used for various other usage.

### REFERENCE SIGNS LIST

10 Terminal
11 Information acquisition unit
12 Information generation unit
13 Information transmission unit
20 Computing device
21 Information receiving unit
22 Information processing unit
23 Device monitoring unit
24 Status transmission unit
31 Camera
32 Velocity sensor
33 Luminance sensor
40 Video processing device
90 Network
100 Information processing device
110 Information receiving unit
120 Information processing unit
120a First-terminal information processing unit
120b Second-terminal information processing unit
120c Camera information processing unit
120d Sensor information processing unit
120e Velocity/luminance information processing unit
130 Information transmission unit
200 Information control device
210 Information processing control unit
211 Information processing method determination unit
211a Second-terminal information processing method determination unit
211b Sensor information processing method determination unit
211c Velocity/luminance information processing method determination unit
212 Storage unit
220 Status receiving unit

1. An information processing device disposed on a communication path between a first terminal and a second terminal that transmit different kinds of information in real time and a computing device that processes the information transmitted from the first terminal, the information processing device comprising:
an information receiving unit, including one or more processors, for receiving the information from the first terminal and the second terminal;
an information processing unit, including one or more processors, for processing the information received from the first terminal, conforming to an information processing rule, based on the information received from the second terminal;
an information transmission unit, including one or more processors, for transmitting, to the computing device, the information from the first terminal that has been processed by the information processing unit; and
an information processing method determination unit, including one or more processors, for determining a processing method for processing the information received from the second terminal in the information processing unit, based on at least one of an information processing status in the computing device and a device status of the computing device, creating the information processing rule, and setting the created information processing rule to the information processing unit.

2. The information processing device according to claim 1, wherein the information processing method determination unit determines the processing method for processing the information received from the second terminal in the information processing unit, creates the information processing rule, and sets the created information processing rule to the information processing unit, so as to satisfy a condition related to an information processing status or a device status required by the computing device.

3. The information processing device according to claim 1, wherein the information processing method determination unit learns a relationship between a change in a result of determining the processing method and a change in at least one of the information processing status in the computing device and the device status of the computing device, and, based on a learning result, determines the processing method for processing the information received from the second terminal in the information processing unit, creates the information processing rule, and sets the created information processing rule to the information processing unit.

4. The information processing device according to claim 1, wherein the information processing method determination unit determines the processing method for processing the information received from the second terminal in the information processing unit, based on a processing status of the information received from the first terminal in the information processing unit, in addition to at least one of the information processing status in the computing device and the device status of the computing device, creates the information processing rule, and sets the created information processing rule to the information processing unit.

5. The information processing device according to claim 1, wherein the information received from the first terminal is video information, and the information received from the second terminal is information indicating a state that affects an image-capturing state of the video information transmitted by the first terminal.

6. A setting method for use in an information processing device disposed on a communication path between a first terminal and a second terminal that transmit different kinds of information in real time and a computing device that processes the information transmitted from the first terminal, the information processing device including:
an information receiving unit, including one or more processors, for receiving the information from the first terminal and the second terminal;
an information processing unit, including one or more processors, for processing the information received from the first terminal, conforming to an information processing rule, based on the information received from the second terminal; and
an information transmission unit, including one or more processors, for transmitting, to the computing device, the information from the first terminal that has been processed by the information processing unit,
the setting method comprising:
a step of determining a processing method for processing the information received from the second terminal in the information processing unit, based on at least one of an information processing status in the computing device and a device status of the computing device,
creating the information processing rule, and
setting the created information processing rule to the information processing unit, by an information processing method determination unit.

7. A non-transitory computer readable medium storing one or more instructions for causing a computer to function as an information processing device that executes a setting method,
the information processing device disposed on a communication path between a first terminal and a second terminal that transmit different kinds of information in real time and a computing device that processes the information transmitted from the first terminal, the information processing device including:
an information receiving unit, including one or more processors, for receiving the information from the first terminal and the second terminal;
an information processing unit, including one or more processors, for processing the information received from the first terminal, conforming to an information processing rule, based on the information received from the second terminal; and
an information transmission unit, including one or more processors, for transmitting, to the computing device, the information from the first terminal that has been processed by the information processing unit, the setting method comprising:
a step of determining a processing method for processing the information received from the second terminal in the information processing unit, based on at least one of an information processing status in the computing device and a device status of the computing device;
creating the information processing rule; and
setting the created information processing rule to the information processing unit, by an information processing method determination unit.

8. The setting method according to claim 6, wherein the information processing method determination unit determines the processing method for processing the information received from the second terminal in the information processing unit, creates the information processing rule, and sets the created information processing rule to the information processing unit, so as to satisfy a condition related to an information processing status or a device status required by the computing device.

9. The setting method according to claim 6, wherein the information processing method determination unit learns a relationship between a change in a result of determining the processing method and a change in at least one of the information processing status in the computing device and the device status of the computing device, and, based on a learning result, determines the processing method for processing the information received from the second terminal in the information processing unit, creates the information processing rule, and sets the created information processing rule to the information processing unit.

10. The setting method according to claim 6, wherein the information processing method determination unit determines the processing method for processing the information received from the second terminal in the information processing unit, based on a processing status of the information received from the first terminal in the information processing unit, in addition to at least one of the information processing status in the computing device and the device status of the computing device, creates the information processing rule, and sets the created information processing rule to the information processing unit.

11. The setting method according to claim 6, wherein the information received from the first terminal is video information, and the information received from the second terminal is information indicating a state that affects an image-capturing state of the video information transmitted by the first terminal.

12. The non-transitory computer readable medium according to claim 7, wherein the information processing method determination unit determines the processing method for processing the information received from the second terminal in the information processing unit, creates the information processing rule, and sets the created information processing rule to the information processing unit, so as to satisfy a condition related to an information processing status or a device status required by the computing device.

13. The non-transitory computer readable medium according to claim 7, wherein the information processing method determination unit learns a relationship between a change in a result of determining the processing method and a change in at least one of the information processing status in the computing device and the device status of the computing device, and, based on a learning result, determines the processing method for processing the information received from the second terminal in the information processing unit, creates the information processing rule, and sets the created information processing rule to the information processing unit.

14. The non-transitory computer readable medium according to claim 7, wherein the information processing method determination unit determines the processing method for processing the information received from the second terminal in the information processing unit, based on a processing status of the information received from the first terminal in the information processing unit, in addition to at least one of the information processing status in the computing device and the device status of the computing device, creates the information processing rule, and sets the created information processing rule to the information processing unit.

15. The non-transitory computer readable medium according to claim 7, wherein the information received from the first terminal is video information, and the information received from the second terminal is information indicating a state that affects an image-capturing state of the video information transmitted by the first terminal.
